(19) United States
(12) Patent Application Publication
(10) Pub. No.: US 2012/0077928 A1
(43) Pub. Date: Mar. 29, 2012

(54) Polymerization using a diallylamine and a compound comprising a macromolecular chain comprising units derived from this amine

(75) Inventor: Mathias Destarac, Paris (FR)

(73) Assignee: Rhodia Operations, Aubervilliers Cedex (FR)

(21) Appl. No.: 13/373,882

(22) Filed: Dec. 5, 2011

Related U.S. Application Data
(63) Continuation of application No. 12/308,945, filed on Nov. 18, 2009, now abandoned.

(30) Foreign Application Priority Data
Jun. 30, 2006 (FR) 0605926

(51) Int. Cl. C08F 293/00; C08F 20/06; C09D 139/00; C08F 20/56

(52) U.S. Cl. 524/533; 525/294; 526/222

(57) ABSTRACT

Compounds containing macromolecular chains and having a structured architecture are prepared by polymerization of macromolecular monomers containing diallylamine structural units.

### CROSS-REFERENCE TO PRIORITY/PCT APPLICATIONS

This application is a continuation of U.S. patent application Ser. No. 12/308,945, filed Nov. 18, 2009 which claims priority under 35 U.S.C. §119 of FR 0605926, filed Jun. 30, 2006, and is a national phase of PCT/EP 2007/056419, filed Jun. 27, 2007 and designating the United States (published in the French language on Jan. 3, 2008, as WO 2008/000766 A2; the title and abstract were also published in English), each hereby expressly incorporated by reference in its entirety and each assigned to the assignee hereof.

The present invention relates to a process for preparing a compound comprising macromolecular chains, using a diallylamine. The present invention also relates to a compound comprising macromolecular chains of controlled architecture, comprising units derived from a diallylamine.

Numerous controlled radical polymerization techniques have been developed in the last 10 years, enabling access relatively easily and inexpensively, from monomers, to a wide variety of macromolecular compounds. Examples that may be mentioned include ATRP techniques, and techniques using nitroxides or alkoxyamines that can generate nitroxides. These polymerization techniques have made it possible to design many novel macromolecular compounds, especially macromolecular compounds of controlled architecture such as block polymers, and to modulate many properties of such compounds. Numerous publications have reviewed controlled radical polymerization techniques, their applications on certain monomers, macromolecular compounds that can be obtained via these techniques, and their properties or uses.

However, for certain monomers, no suitable polymerization technique of controlled radical type has ever been described, and no macromolecular compound of controlled architecture derived from these monomers has ever been described. Limitations exist for the design and modulation of properties of macromolecular compounds, and for the manufacture thereof. There is a need for polymerization techniques and for polymers that are outside these limits. There is in particular a need for macromolecular compounds of controlled architecture bearing cationic or potentially cationic groups, which have great stability in many environments, modulated properties, a low cost price and/or are easy to access especially via the monomers used.

The invention satisfies at least some of the needs mentioned above, by proposing a process for preparing a compound comprising macromolecular chains, comprising a “step P” of radical polymerization in which the following are placed in contact:
at least one “monomer M” chosen from tertiary or quaternary diallylamines, where appropriate in the form of a salt,
optionally, other ethylenically unsaturated monomers,
at least one compound comprising a transfer group comprising a group of formula —S—CS—, and
a compound bearing or generating free radicals.

The invention also proposes, in order to satisfy at least some of the needs mentioned above, a compound comprising macromolecular chains of controlled architecture, characterized in that:
the macromolecular chains comprise at least 10% by number, preferably at least 50% and preferably at least 90% of units derived from ethylenically unsaturated monomers,
the macromolecular chains comprise units derived from at least one “monomer M” chosen from tertiary or quaternary diallylamines, where appropriate in the form of a salt.

It is mentioned that the compound of the invention can be obtained by means of the process of the invention. It is also mentioned that a controlled architecture of macromolecular chains comprising units derived from ethylenically unsaturated monomers is generally associated with a controlled or “living” polymerization process, preferably a controlled radical polymerization process. Controlled radical polymerization processes using transfer groups of formula —S—CS— allow access to such compounds. Such compounds may be prepared simply and/or economically via such processes.

### DEFINITIONS

In the present patent application, the term unit derived from a monomer, other than a monomer M denotes a unit that may be obtained directly from said polymerization monomer. Thus, for example, a unit derived from an acrylic or methacrylic acid ester does not cover a unit of formula —CH₂—CH(COOH)—, or —CH₂—C(CH₃)(COOH)—, obtained, for example, by polymerizing an acrylic or methacrylic acid ester, followed by hydrolyzing. For example also, a unit derived from acrylic or methacrylic acid denotes a unit of formula —CH₂—CH(COOH)— or —CH₂—C(CH₃)(COOH)— even if these units have been obtained by polymerizing an acrylic or methacrylic acid ester, followed by hydrolyzing.

In the present patent application, the term “unit derived from a monomer M” denotes a unit that may be obtained directly from said monomer, with a possible rearrangement such as a cyclization in the form of a heterocycle comprising a nitrogen atom, and, where appropriate, with a possible chemical modification (for example by chloroalkylation to quaternize a secondary amine).

In the present patent application, the term “monomer other than the monomer M” denotes a monomer that is not a ternary or quaternary diallylamine, where appropriate in the form of a salt, especially as described below. These monomers and the units derived therefrom are also noted as other monomers or other units.

In the present patent application, a “monomer composition” used during a polymerization step is defined by the nature and the relative amount of monomers. It may be a single monomer. It may be a combination of several monomers (comonomers), of different nature, in different proportions. Similarly, a composition of a macromolecular chain or a composition of units of a macromolecular chain is defined by the nature and the relative amount of the monomers from which the units of the macromolecular chain are derived. It may be a macromolecular chain derived from a single monomer (homopolymer chain). It may be a macromolecular chain whose units are derived from several monomers of different nature, in different proportions (copolymer chain).

In the present patent application, a “different monomer composition” denotes a composition in which the nature of the monomer(s) and/or in which the proportions of different monomers are different. This is likewise, by analogy, the case for a different macromolecular chain or a different unit composition. A monomer composition comprising 100% of a monomer M¹ is different than a composition comprising 100% of a monomer M². A monomer composition comprising 50% of a monomer M¹ and 50% of a monomer A¹ is different than a composition comprising 10% of a monomer M¹ and 90% of a monomer A¹. A monomer composition comprising 50% of a monomer M¹ and 50% of a monomer A¹ is different than a composition comprising 50% of the monomer M¹ and 50% of a monomer A².

In the present patent application, to simplify, the units derived from a monomer will occasionally be likened to the monomer itself, and reciprocally.

In the present patent application, an ethylenically unsaturated monomer is a compound comprising a polymerizable carbon-carbon double bond. It may be a monoethylenically unsaturated monomer, preferably an α-monoethylenically unsaturated monomer, or a polyethylenically unsaturated monomer. In the present patent application, for the different compounds of star copolymers or star microgels, and for different processes for preparing star copolymers or star microgels, an ethylenically unsaturated monomer denotes a monoethylenically unsaturated monomer, preferably an α-monoethylenically unsaturated monomer.

Monomer M and Units Derived from the Monomer M

The monomer M is a tertiary or quaternary diallylamine optionally in the form of a salt. It may be a mixture or a combination of several of these amines. It is mentioned that the monomer and the units derived from the monomer M may be in various forms, especially as a function of the pH of the medium in which they are present (protonation on acidifying). They may be in the form of salts, either permanently at any pH (quaternary amines), or as a function of the pH. Certain monomers M of quaternary amine type, and the units derived therefrom, bearing a substituent (of type R³ in particular) comprising a negative charge are occasionally referred to as betaines, and are not generally considered as being in the form of salts. The monomers M in the form of salts, and the units derived therefrom, generally comprise a counter-anion X⁻.

Monomers M are, for example, monomers having the following formulae:

CH₂═CH—CH₂—NR¹—CH₂—CH═CH₂ (I)

CH₂═CH—CH₂—N⁺R¹R²—CH₂—CH═CH₂,X⁻ (II)

CH₂═CH—CH₂—N⁺R¹R³CH₂—CH═CH₂ (III)

in which:
R¹ is a linear or branched, saturated or unsaturated hydrocarbon-based group, possibly aromatic, possibly substituted, preferably of C₁-C₃₀. R¹ is preferably a methyl or ethyl group,
R² is a hydrogen atom or an identical or different group of formula R¹, forming, where appropriate, with the group R¹, an optionally heterocyclic, optionally aromatic ring. R² is preferably a methyl or ethyl group,
X⁻ is an anion, preferably, for example, a Cl⁻, Br⁻, methyl sulfate or ethyl sulfate anion,
R³ is a linear or branched, saturated or unsaturated hydrocarbon-based group, which is possibly aromatic, possibly substituted, comprising at least one group bearing a negative charge, preferably of C₁-C₃₀, forming, where appropriate, with the group R¹, an optionally heterocyclic, optionally aromatic ring. R³ may especially be a carboxyalkyl, sulfoalkyl or phosphonoalkyl group in which the alkyl contains from 1 to 3 carbon atoms.

Examples of monomers M that are mentioned include:
the monomer M is diallyldimethylammonium chloride (DADMAC). This monomer is a monomer of formula (II) in which R¹═R²═CH₃ and X⁻═Cl⁻,
the monomer of formula CH₂═CH—CH₂—N(CH₃)—CH₂—CH═CH₂. This monomer is a monomer of formula (I) in which R¹═CH₃,
the monomer of formula:

CH₂═CH—CH₂—N⁺(CH₃)(CH₂—CH₂—CH₂—SO₃⁻)—CH₂—CH═CH₂
this monomer is a monomer of formula (III) in which R¹═CH₃ and R³═(CH₂)₃—SO₃⁻,
the monomer of formula:

CH₂═CH—CH₂—N⁺(CH₃)(CH₂—CH₂—CH₂—COO⁻)—CH₂—CH═CH₂
this monomer is a monomer of formula (III) in which R¹═CH₃ and R³═(CH₂)₃—COO⁻.

Units derived from the monomers M may especially be in cyclized form, in the form of a heterocycle comprising a nitrogen atom. This cyclization may be due to a rearrangement that takes place during the polymerization step P. Advantageously, at least 50% by number, preferably at least 90%, or even all, of the units derived from the monomer M are in the form of a heterocycle comprising the nitrogen atom. This form may especially contribute toward good chemical stability of the compounds comprising the macromolecular chain, especially in hostile media in terms, for example, of pH, temperature and/or presence of molecules liable to degrade polymerized units, in particular cationic units.

The cyclization and the heterocycles may especially be revealed by NMR analysis (disappearance of the two allylic protons, characteristic shifts of the protons borne by the carbons adjacent to the heteroatom, and possibly characteristic shifts of these carbons).

The units derived from monomers M in the form of a heterocycle comprising a nitrogen atom may especially have the following formulae, in which R¹, R², R³ and X⁻ are as defined above:

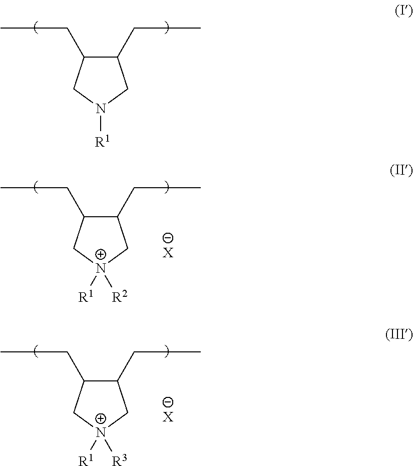

Other Monomers—Other Units

The process according to the invention can use monomers other than the monomer M. The macromolecular compound according to the invention may comprise units other than the units derived from a monomer M.

These monomers may especially be polymerized at the same time, during the same step, as the monomer M (copolymerization). They may also or alternatively be polymerized during other polymerization steps, for example to obtain compounds of controlled architecture comprising several parts, for example block copolymers.

The other monomers and the units derived therefrom may especially be:
hydrophilic or hydrophobic monomers or units,
anionic, potentially anionic, cationic, potentially cationic, zwitterionic or neutral monomers or units, and/or
monomers or units of varied glass transition temperatures, for example below −100° C., for example between −100° C. and −55° C., between −55° C. and 0° C., between 0° C. and +55° C., between +55° C. and +100° C., or above +100° C.

The properties and uses of the compounds according to the invention may be modulated by means of these other monomers or other units, especially using the monomers, their proportions and their place in the architecture of the compound, according to the above criteria. The monomers are often classified according to these criteria, and values relating to these criteria for the various monomers are usually tabulated and available in the literature.

As examples of potentially cationic monomers from which potentially cationic units may be derived, mention may be made of:
N,N-(dialkylamino-ω-alkyl)amides of α,β-monoethylenically unsaturated carboxylic acids, for instance N,N-dimethylaminomethyl-acrylamide or
methacrylamide, 2-(N,N-dimethylamino)ethyl-acrylamide or
methacrylamide, 3-(N,N-dimethylamino)propyl-acryl-amide or
methacrylamide and 4-(N,N-dimethylamino)-butyl-acrylamide or
methacrylamide
α,β-monoethylenically unsaturated amino esters, for instance 2-(dimethylamino)ethyl acrylate (DMAEA), 2-(dimethylamino)ethyl methacrylate (DMAEMA), 3-(dimethylamino)propyl methacrylate, 2-(tert-butylamino)ethyl meth-acrylate, 2-(dipentylamino)ethyl methacrylate or 2-(diethylamino)ethyl methacrylate
vinylpyridines
vinylamine
vinylimidazolines
monomers that are precursors of amino functions such as N-vinyl-formamide, N-vinylacetamide, etc., which give rise to primary amine functions by simple acidic or basic hydrolysis.

As examples of cationic monomers from which potentially cationic units may be derived, mention may be made of:
ammoniumacryloyl or -acryloyloxy monomers, for instance:
   trimethylammoniumpropyl methacrylate salts, in particular the chloride,
   trimethylammoniumethylacrylamide or -methacryl-amide chloride or bromide,
   trimethylammoniumbutylacrylamide or -methacryl-amide methyl sulfate,
   trimethylammoniumpropylmethacrylamide methyl sulfate (MAPTA MeS),
   (3-methylacrylamidopropyl)trimethylammonium chloride (MAPTAC),
   (3-acrylamidopropyl)trimethylammonium chloride or methyl sulfate (APTAC or APTA MeS),
   methacryloyloxyethyltrimethylammonium chloride or methyl sulfate,
   acryloyloxyethyltrimethylammonium (ADAMQUAT) salts, for instance acryloyloxyethyltrimethyl-ammonium chloride; or acryloyloxyethyltrimethyl-ammonium methyl sulfate (ADAMQUAT Cl or ADAMQUAT MeS),
methyldiethylammonium ethyl acrylate methyl sulfate (ADAEQUAT MeS),
benzyldimethylammonium ethyl acrylate chloride or methyl sulfate (ADAMQUAT BZ 80),
1-ethyl-2-vinylpyridinium or 1-ethyl-4-vinylpyridinium bromide, chloride or methyl sulfate;
dimethylaminopropylmethacrylamide, N-(3-chloro-2-hydroxypropyl)trimethylammonium chloride (DIQUAT chloride),
dimethylaminopropylmethacrylamide, N-(3-methylsulfate-2-hydroxypropyl)trimethylammonium methyl sulfate (DIQUAT methyl sulfate),
the monomer of formula:

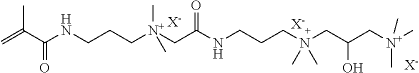

in which X⁻ is an anion, preferably chloride or methyl sulfate.

As examples of hydrophilic neutral monomers from which hydrophilic neutral units may be derived, mention may be made of:
hydroxyalkyl esters of α,β-ethylenically unsaturated acids, for instance hydroxyethyl or hydroxypropyl acrylates and methacrylates, glyceryl mono-meth-acrylate, etc.
α,β-ethylenically unsaturated amides, for instance acrylamide, N,N-dimethylmethacrylamide, N-methylolacrylamide, etc.
α,β-ethylenically unsaturated monomers bearing a water-soluble polyoxyalkylene segment of the polyethylene oxide type, for instance polyethylene oxide α-methacrylates (Bisomer S20W, S10W, etc. from Laporte) or α,ω-dimethacrylates, Sipomer BEM from Rhodia (ω-behenyl polyoxyethylene methacrylate), Sipomer SEM-25 from Rhodia (ω-tristyrylphenyl polyoxyethylene methacrylate), etc.
vinyl alcohol,
α,β-ethylenically unsaturated monomers that are precursors of hydrophilic units or segments such as vinyl acetate, which, once polymerized, can be hydrolyzed to generate vinyl alcohol units or polyvinyl alcohol segments
vinyllactams, especially vinylpyrrolidone and vinylcaprolactam,
α,β-ethylenically unsaturated monomers of ureido type and in particular 2-imid-azolidinone-ethyl methacrylamide (Sipomer WAM II from Rhodia),
nonethylene glycol methyl ether acrylate or nonethylene glycol methyl ether methacrylate.

As examples of hydrophobic neutral monomers from which hydrophobic neutral units may be derived, mention may be made of:
vinylaromatic monomers such as styrene, α-methylstyrene, vinyltoluene, etc.,
vinyl or vinylidene halides, for instance vinyl chloride or vinylidene chloride,
C₁-C₁₂ alkyl esters of α,β-monoethylenically unsaturated acids such as methyl, ethyl or butyl acrylates and methacrylates, 2-ethylhexyl acrylate, etc.,
vinyl or allylic esters of saturated carboxylic acids such as vinyl or allyl acetates, propionates, versatates, stearates, etc.,
α,β-monoethylenically unsaturated nitriles containing from 3 to 12 carbon atoms, for instance acrylonitrile, methacrylonitrile, etc.,
α-olefins, for instance ethylene, etc.,
conjugated dienes, for instance butadiene, isoprene, chloroprene, etc.,
monomers capable of generating polydimethylsiloxane (PDMS) chains. Thus, part A may be a silicone, for example a polydimethylsiloxane chain or a copolymer comprising dimethylsiloxy units,
diethylene glycol ethyl ether acrylate or diethylene glycol ethyl ether methacrylate.

As examples of anionic or potentially anionic monomers, from which anionic or potentially anionic units may be derived, mention may be made of:
monomers containing at least one carboxylic function, for instance α,β-ethylenically unsaturated carboxylic acids or the corresponding anhydrides, such as acrylic, methacrylic or maleic acid or anhydride, fumaric acid, itaconic acid, N-methacryloyl alanine and N-acryloylglycine and the water-soluble salts thereof
monomers that are precursors of carboxylate functions, for instance tert-butyl acrylate, which generate, after polymerization, carboxylic functions by hydrolysis
monomers containing at least one sulfate or sulfonate function, for instance 2-sulfooxyethyl methacrylate, vinylbenzenesulfonic acid, allylsulfonic acid, 2-acrylamido-2-methylpropanesulfonic acid, sulfoethyl acrylate or methacrylate, and sulfopropyl acrylate or methacrylate, and the water-soluble salts thereof
monomers containing at least one phosphonate or phosphate function, for instance vinylphosphonic acid, etc., ethylenically unsaturated phosphate esters such as the phosphates derived from hydroxyethyl methacrylate (Empicryl 6835 from Rhodia) and those derived from polyoxyalkylene methacrylates, and the water-soluble salts thereof.

As examples of zwitterionic monomers from which zwitterionic units A may be derived, mention may be made of:
monomers bearing a carboxybetaine group,
monomers bearing a sulfobetaine group, for example sulfopropyl dimethyl ammonium ethyl methacrylate (SPE), sulfoethyl dimethyl ammonium ethyl methacrylate, sulfobutyl dimethyl ammonium ethyl acrylate, sulfohydroxypropyl dimethyl ammonium ethyl methacrylate (SHPE), sulfopropyl dimethylammonium propyl acrylamide, sulfopropyl dimethylammonium propyl methacrylamide (SPP), sulfohydroxypropyl dimethylammonium propyl methacrylamide (SHPP), sulfopropyl diethyl ammonium ethyl methacrylate or sulfohydroxypropyl diethyl ammonium ethyl methacrylate,
monomers bearing a phosphonobetaine group, for instance phosphatoethyl trimethylammonium ethyl methacrylate.

Monomers other than the monomer M that are particularly advantageous are the following monomers:
acrylamide, methacrylamide,
acrylic acid, methacrylic acid,
vinyllactams, especially vinylpyrrolidone and vinyllactam,
acrylic or methacrylic acid esters,
acrylamide or methacrylamide amides,
vinyl alcohol esters.

Compounds Comprising the Macromolecular Chain

The compound according to the invention comprises a macromolecular chain of controlled architecture. It may especially be a hybrid compound comprising an inorganic part, for example an inorganic particle such as a silica particle, to which are attached macromolecular chains, generally obtained by growth on the inorganic particle. According to one preferred embodiment, the compound is a polymer, preferably a copolymer of controlled architecture, constituted of macromolecular chains of controlled architecture, not comprising an inorganic part.

The macromolecular chains of controlled architecture may typically be obtained by means of one or more controlled radical polymerization steps, involving transfer groups of formula —S—SC—.

The macromolecular chains of controlled architecture may especially:
comprise at least one macromolecular part A and one macromolecular part B, in which:
   part A is of different composition than part B, and
   part B comprises the units derived from the monomers M, and/or
comprise a nonpolymeric branching center, and macromolecular chains comprising units derived from the monomer M, these chains being connected to the branching center. It may especially be a star polymer obtained by growing macromolecular chains on a nonpolymeric agent, comprising at least 3 transfer groups connected via a nonpolymeric organic group that will constitute the branching center after polymerization, for example an agent of the type R—(S—CS—Z¹)ₚ in which p is greater than or equal to 3 and R is the nonpolymeric organic group that will constitute the branching center. The macromolecular chains may be homopolymeric or copolymeric, where appropriate copolymeric containing blocks as described hereinbelow.

The compound, preferably a copolymer of controlled architecture, may especially have one of the following structures:
a block copolymer comprising at least two blocks, part A corresponding to one block (block A), part B corresponding to another block (block B). Block B may be defined as being the block comprising the monomer M,
a concentration-gradient copolymer, part A corresponding to a part that is less rich in monomer M than part B,
a comb copolymer, having a backbone and side chains, with part A corresponding to the backbone and part B corresponding to the side chains, or with part B corresponding to the backbone and part A corresponding to the side chains. Part B may be defined as being the part comprising the monomer M,
a star copolymer or star microgel comprising a polymer core and peripheral macromolecular chains, at least part of the part A or B corresponding to the core, the other part corresponding to the peripheral chains. Part B may be defined as being the part comprising the monomer M.

According to one particular embodiment, part A is derived from ethylenically unsaturated monomers.

These structures especially have in common the fact that they can be obtained by means of the process according to the invention. A person skilled in the art can determine the type of process that can be used and the useful sequences of steps. One of the steps may be the polymerization step P. Reference is also made to the “Processes” section hereinbelow.

According to one particular embodiment, the compound is a block copolymer, preferably a linear block copolymer, comprising at least one block A and at least one block B, preferably a diblock copolymer (block A)-(block B) or a triblock copolymer (block A)-(block B)-(block A) or (block B)-(block A)-(block B), in which:
block B comprises units derived from the monomer M and optionally other monomers,
block A comprises units derived from monomers other than the monomer M, and optionally units derived from the monomer M,
the composition of block A is different than the composition of block B, the numerical amount of monomer M in block A preferably being less than that of block B, for example zero.

It is mentioned that the triblock copolymers obtained via processes using three successive polymerization sequences are often described as copolymers containing blocks (block A)-(block B)-(block C). When the composition and the molecular mass of the third block C are substantially identical to the composition and molecular mass of the first block A (the amounts and proportions of (co)monomers being substantially identical), the triblock copolymers may be described as triblock copolymers A-B-A′ or, by extension or simplification, as triblock copolymers A-B-A.

The macromolecular chains may, for example, have an average molar mass of between 1000 g/mol and 2 000 000 g/mol, often an average molar mass of between 2000 g/mol and 100 000 g/mol. This may be a theoretical average molar mass, calculated from the amounts of monomers used and of the optional transfer agents used, in a manner known to those skilled in the art. It may be a number-average molar mass, measured by steric exclusion chromatography (SEC).

Parts A and/or B, in which part B at least comprises units derived from the monomer M, may have an average molar mass of between 500 g/mol and 1 000 000 g/mol and often an average molar mass of between 1000 g/mol and 100 000 g/mol. This may be a theoretical average molar mass, calculated from the amounts of monomers used and of the optional transfer agents used, for the preparation of the part under consideration. It may be a number-average molar mass, measured by steric exclusion chromatography (SEC). The measured average molecular mass of a part obtained by polymerization subsequent to a preceding polymerization is defined as the average molar mass measured after the polymerization subsequent to which is deducted the average molar mass measured after the preceding polymerization.

The weight ratio between part A and part B, in which part B at least comprises units derived from the monomer M, may be, for example, between 1/100 and 100/1. It may be a weight ratio between the monomers used to generate part A and part B. It may be a weight ratio between the theoretical or measured average molar masses of part A and of part B.

By way for example, the compound may be a linear block copolymer of diblock type (block A)-(block B), of triblock type (block A)-(block B)-(block A) or of triblock type (block B)-(block A)-(block B), in which block B comprises units derived from the monomer M, having a theoretical or measured average molar mass of between 1000 g/mol and 2 000 000 g/mol, often an average molar mass of between 2000 g/mol and 100 000 g/mol. The block(s) A may especially be one (or more) block(s) with a theoretical or measured average molar mass of between 500 g/mol and 1 000 000 g/mol, often an average molar mass of between 1000 g/mol and 100 000 g/mol. The block(s) B may especially be one (or more) block(s) with a theoretical or measured average molar mass of between 500 g/mol and 1 000 000 g/mol, often an average molar mass of between 1000 g/mol and 100 000 g/mol. The weight ratio between the block(s) A and the block(s) B may especially be between 1/100 and 100/1.

Polymerization Step P—Processes

The process according to the invention uses the polymerization step P described above. Depending on the compound to be prepared, the process may comprise other prior or subsequent steps.

During the polymerization step P, the monomer M preferably represents from 1% to 100% and preferably from 10% to 100% by number of the monomers used during the polymerization step P.

In addition, the process may comprise:
before or after the polymerization step P, another step of radical polymerization in which the following are placed in contact:
   ethylenically unsaturated monomers, in a composition different than that of the polymerization step P,
   at least one compound comprising a transfer group comprising a group of formula —S—CS—, and
   a compound bearing or generating free radicals, and/or
after the polymerization step(s), a step of chemical modification of the macromolecular chains and/or of deactivation of the transfer groups borne by the macromolecular chains, of destruction or purification of by-products of the chemical modification and/or deactivation.

It is mentioned that the other polymerization step may constitute a step P if it uses the monomer M. In this case, it may be denoted, for example, as a polymerization step P′.

If successive polymerizations are performed, it is, however, preferred for the polymerization step P to be subsequent to a step not using monomer M, or using less than 50% by number and preferably less than 10% by number.

Steps for chemical modification of the macromolecular chains are directed toward adding to the chains functional groups, removing groups from the macromolecular chains or substituting groups of macromolecular chains. These groups may especially be borne by units derived from monomers or borne at the ends of a macromolecular chain. Such processes are known to those skilled in the art. Mention is made, for example, of total or partial hydrolysis steps, or total or partial crosslinking steps.

The deactivation of transfer groups borne by the macromolecular chains, and/or purification and/or destruction of by-products of the chemical modification and/or deactivation, may be performed. It may be a reaction for the purification or destruction of certain species, for example via processes of the type such as hydrolysis, oxidation, reduction, pyrolysis, ozonolysis or substitution. An oxidation step with hydrogen peroxide is particularly suitable for treating sulfur-bearing species. It is mentioned that some of these reactions or operations may take place totally or partially during a chemical modification step.

The polymerization step P uses a compound comprising a transfer group of formula —S—CS—. According to one embodiment, it is an inorganic compound, for example inorganic particles, on which are present transfer groups of formula S—CS—, these groups having been grafted, for example. According to one embodiment, it is a polymeric compound onto which have been grafted transfer groups of formula S—CS—. This embodiment is especially suited to the preparation of comb copolymers whose side chains comprise units derived from the monomer M, or block copolymers comprising a silicone block. According to one embodiment, it is a nonpolymeric transfer agent comprising a transfer group of formula —S—CS—. According to one embodiment, the compound comprising a transfer group of formula —S—CS— is a macromolecular compound obtained during a preceding polymerization step, which may have used a compound comprising a transfer group comprising a group of formula —S—CS—. Typically, the first polymerization step uses an inorganic compound on which the transfer groups are present, or a nonpolymeric transfer group comprising a transfer group of formula —S—CS—.

Transfer groups of formula —S—CS— and compounds comprising these groups, especially transfer agents, are known to those skilled in the art and are described in the literature. They may especially be selected according to their reactivity toward certain monomers and/or their solubility in the reaction medium.

The transfer group may especially comprise a group of formula —S—CS—Z— in which Z is an oxygen atom, a carbon atom, a sulfur atom, a phosphorus atom or a silicon atom, these atoms being, where appropriate, substituted so as to have a suitable valency.

Useful agents, groups or processes are especially described in the following documents:
the processes and agents of patent applications WO 98/58974, WO 00/75207 and WO 01/42312 which use a radical polymerization controlled by control agents of xanthate type (—S—CS—O— group),
the radical polymerization process and agents controlled by control agents of dithioester type (—S—CS-carbon group) or trithiocarbonate type (—S—CS—S— group) of patent application WO 98/01478,
the radical polymerization process and agents controlled by control agents of dithiocarbamate type (—S—CS-nitrogen group) of patent application WO 99/31144,
the radical polymerization process and agents controlled by control agents of dithiocarbazate type (—S—CS-nitrogen group) of patent application WO 02/26836,
the radical polymerization process and agents controlled by control agents of dithiophosphoroester type (—S—CS—O— group) of patent application WO 02/10223,
the agents of xanthate, dithiocarbonate and/or trithiocarbonate type described in documents WO 02/70571; WO 2001/060 792; WO 2004/037 780; WO 2004/083 169; WO 2003/066 685; WO 2005/068 419; WO 2003/062 280; WO 2003/055 919; WO 2006/023 790, and the processes using them.

Particularly useful transfer agents that may be mentioned include:
—O-ethyl-S-(1-methoxycarbonylethyl)xanthate of formula (CH₃CH(CO₂CH₃))S(C═S)OEt
dibenzyl trithiocarbonate of formula φ-CH₂—S—CS—S—CH₂-φ
phenyl benzyl dithiocarbonate of formula φ-S—CS—CH₂-φ
N,N-diethyl S-benzyl dithiocarbamate of formula (CH₃—CH₂)₂N—CS—S—CH₂-φ.

In the process according to the invention, these agents may be used during at least one polymerization step.

The polymerization step P uses a compound bearing or generating free radicals. According to one embodiment, it is a nonpolymeric initiating compound. Such compounds are known to those skilled in the art. According to another embodiment, the compound bearing or generating free radicals is present in a polymerization product from a preceding step. In this case, the use of an initiator is optional. In general, when several successive polymerization steps are used, it is preferred to add an amount of initiator in each step.

As examples of initiators that may be used, mention is made of:

They may be, for example, one of the following initiators:
hydrogen peroxides such as: tert-butyl hydroperoxide, cumene hydroperoxide, t-butyl peroxyacetate, t-butyl peroxybenzoate, t-butyl peroxyoctoate, t-butyl peroxyneodecanoate, t-butyl peroxyisobutarate, lauroyl peroxide, t-amyl peroxypivalate, t-butyl peroxypivalate, dicumyl peroxide, benzoyl peroxide, potassium persulfate, ammonium persulfate,
azo compounds such as: 2-2′-azobis(isobutyronitrile), 2,2′-azobis(2-butanenitrile), 4,4′-azobis(4-pentanoic acid), 1,1′-azobis (cyclohexanecarbonitrile), 2-(t-butylazo)-2-cyanopropane, 2,2′-azobis[2-methyl-N-(1,1)-bis(hydroxymethyl)-2-hydroxyethyl]propionamide, 2,2′-azobis(2-methyl-N-hydroxyethyl]propionamide, 2,2′-azobis(N,N′-dimethyleneisobutyramidine)dichloride, 2,2′-azobis(2-amidinopropane)dichloride, 2,2′-azobis(N,N′-dimethyleneisobutyramide), 2,2′-azobis(2-methyl-N-[1,1-bis(hydroxymethyl)-2-hydroxyethyl]propionamide), 2,2′-azobis(2-methyl-N-[1,1-bis(hydroxymethyl)ethyl]propionamide), 2,2′-azobis[2-methyl-N-(2-hydroxyethyl)propionamide], 2,2′-azobis(isobutyramide)dihydrate,
redox systems comprising combinations such as:
   mixtures of hydrogen peroxide, alkyl peroxide, peresters, percarbonates and the like and of any iron salts, titanous salts, zinc formaldehyde sulfoxylate or sodium formaldehyde sulfoxylate, and reducing sugars,
   alkali metal or ammonium persulfates, perborate or perchlorate in combination with an alkali metal bisulfite, such as sodium metabisulfite, and reducing sugars,
   alkali metal persulfates in combination with an arylphosphinic acid, such as benzenephosphonic acid and the like, and reducing sugars.

For correct functioning, especially in terms of speed, of the polymerization step P, it is advantageous to work at relatively high monomer concentrations in the polymerization medium, preferably of at least 40% or even of at least 50% by weight. It is preferred to work at moderate temperature, for example between 30 and 70° C., typically at about 50° C.

The polymerization step P, and/or the other polymerization steps, may especially be performed by solution polymerization (for example in aqueous, alcoholic or hydroxy-alcoholic solution), or by bulk or emulsion polymerization. The polymerization step P may especially be performed in inverse emulsion, especially when the monomer M is DADMAC.

For example, for the preparation of block copolymers, it is possible to perform a first polymerization step in the presence of transfer groups to generate a first block, and then a second polymerization step (the transfer groups still being present) with a monomer composition that is different than that of the preceding step, to generate a second block, and optionally other polymerization steps, with monomer compositions different than those of the preceding step, to generate other blocks. The first step may be a step P using the monomer M, the second step may be a step P using the monomer M, and the other steps may be steps P using the monomer M.

Thus, according to one embodiment:
the macromolecular compound is a block copolymer comprising at least one block A and one block B,
the block B comprises units derived from the monomer M,
the process comprises at least the following steps:
   a) preparation of block A: radical polymerization step in which the following are placed in contact:
      ethylenically unsaturated monomers,
      at least one transfer agent comprising a transfer group comprising a group of formula —S—CS—,
      at least one compound generating free radicals,
   b) growth of block B: the polymerization step P, in which the following are placed in contact:
      the product obtained in step a), comprising as block A a macromolecular chain comprising the transfer group, and optionally a compound bearing or generating free radicals,
      at least the monomer M,
      optionally other monomers, and
      a compound bearing or generating free radicals, if the product obtained in step a) does not comprise any,
the composition of the monomer(s) used during step a) being different than the composition of the monomer(s) used during step b). Preferably, the monomer(s) used during step A do(es) not comprise any monomer M.

To obtain diblock copolymers (block A)-(block B), no polymerization steps other than steps a) and b) above are performed.

It is especially possible to prepare triblock copolymers A-B-A in two polymerization sequences, using agents comprising two transfer groups or agents comprising a transfer group allowing a transfer at each end of the group, for example a trithiocarbonate comprising a group of formula —S—CS—S—. In such processes, the blocks A are entirely identical, and block B generally comprises a central group that is different than the repeating units of block B. Mention of the presence of a central group within block B, noted, for example, as —X—, —X—Z′—X— or R′ hereinbelow, is often omitted for the sake of simplification.

Thus, triblock copolymers A-B-A may be prepared via the following process:
step a′): preparation of the polymer of formula R-A-X-A-R by polymerization in the presence of at least one control agent of formula R—X—R in which R, which may be identical or different, is an organic group, and X is a transfer group, the agent being a trithiocarbonate comprising a group —X— of formula —S—CS—S— and preferably two identical groups R such as benzyl groups (the agent thus being, for example, dibenzyl trithiocarbonate),
step b′): production of the triblock copolymer R-A-B—X—B-A-R (or more simply A-B-A), by growth of block B on the blocks A by controlled radical polymerization.

Triblock copolymers A-B-A may also be prepared via the following process:
step a″): preparation of a polymer of formula R-A-X—Z′—X-A-R by polymerization in the presence of at least one control agent of formula R—X—Z′—X—R in which R, which may be identical or different, is an organic group, Z′ is a divalent organic group, and X is a transfer group comprising a group —S—CS—, said agent being, for example:
   an agent comprising two xanthate groups, in which —X— is a group of formula —S—CS— forming with —Z′— a group of formula —S—CS—O— (xanthate), Z′ being, for example, a group of formula —O—CH₂—CH₂—O—, and R is, for example, a benzyl group or a group of formula H₃C—OOC—CH(CH₃)—, or
   an agent comprising two dithioester groups, in which —X— is a group of formula —S—CS— forming with —Z′— a group of formula —S—CS—C— (dithioester), Z′ being, for example, a phenyl or benzyl group, or a group of formula —CH₂—C₆H₅—CH₂—, and R is, for example, a benzyl group,
step b″): production of the triblock copolymer R-A-B—X—Z′—X—B-A-R (or more simply A-B-A), by growth of the block B on the blocks A by controlled radical polymerization.

Triblock copolymers A-B-A may also be prepared via the following process:
step a): preparation of a polymer of formula Z—X—B—R′—B—X—Z using a control agent of formula Z—X—R′—X—Z in which Z, which may be identical or different, is an organic group, R′ is a divalent organic group, and X is a transfer group, comprising a group —S—CS—, said agent being, for example:
   an agent comprising two xanthate groups, in which —X— is a group of formula —S—CS— forming with Z— a group of formula —O—CS—S— (xanthate), Z— being, for example, an ethoxy group, and —R′— is, for example, a phenyl or benzyl group or a group of formula —CH₂—C₆H₅—CH₂—, or
   an agent comprising two dithioester groups, in which —X— is a group of formula —S—CS— forming with Z— a group of formula C—CS—S— (dithioester), Z— being, for example, a phenyl or benzyl group, and —R′— is, for example, a phenyl or benzyl group, or a group of formula —CH₂—C₆H₅—CH₂—,
step b): production of the triblock copolymer Z—X-A-B—R′—B-A-X—Z (or more simply A-B-A), by growth of block A on the blocks B by controlled radical polymerization.

Concentration-gradient copolymers may be obtained via a polymerization step P during which the proportion of monomer M relative to the other monomers is gradually reduced.

Comb copolymers comprising a part B corresponding to the side chains may be obtained by means of a step P of polymerization of the monomer M or of a monomer mixture comprising the monomer M, in which the macromolecular chains are grown on transfer groups present (for example grafted) on a backbone A prepared beforehand. The backbone A may be a polymer derived from an ethylenically unsaturated monomer, or another backbone, for example a polysaccharide or a silicone.

Comb copolymers comprising a part B corresponding to the backbone may be obtained by means of a step P of polymerization of the monomer M or of a monomer mixture comprising the monomer M, followed by grafting or growth of the macromolecular chains corresponding to the part A, on units preferably derived from monomers other than the monomers M.

Star copolymers or star microgels comprising a part A and a part B may especially be obtained via “arm first” or “core first” processes, which are described especially for other monomers in documents WO 00/02939 (arm first) and WO 2004/014 535 (core first).

The “arm first” process involves a step of linear polymerization in the presence of ethylenically unsaturated monomers and of a compound comprising a transfer group of formula —S—CS—, followed by a step of formation of a core by polymerization in the presence of the product from the preceding polymerization step and of polyethylenically unsaturated monomers. The polymerization step P may be a step of linear polymerization and/or the core-forming step, the monomer M being used in at least one of the steps.

The “core first” process involves a step of forming a core by polymerization in the presence of a transfer agent comprising a transfer group of formula —S—CS— and of polyethylenically unsaturated monomers, followed by a step of linear polymerization in the presence of ethylenically unsaturated monomers and of the product from the preceding core-forming step. The polymerization step P may be the step of linear polymerization and/or the core-forming step, the monomer M being used in at least one of these steps.

Uses

The compounds comprising macromolecular chains according to the invention, and/or the compounds obtained or that may be obtained by means of the process according to the invention, may be used in many industrial sectors.

They may especially be used:
in water-treatment or waste-processing processes,
in cosmetic compositions,
in household maintenance compositions (laundry products and products for cleaning hard surfaces or for washing kitchenware by hand or in a machine),
in industrial textile-treatment compositions, or
in coating compositions, for example paints, or plastics.

In these fields, they may be used as:
flocculent, for example in water-treatment or waste-processing processes,
agent for treating and/or modifying a surface, for example the surface of the hair or the skin (cosmetic compositions) for conditioning them, or domestic surfaces (household maintenance compositions), whether for laundry care (for softening or facilitating ironing), for washing kitchenware (reduction of marks) or for hard surfaces (reduction of marks),
rheological agent, for example in household maintenance compositions or in cosmetic compositions,
antistatic agent or electricity-conducting agent, for example in industrial textile-treatment compositions or in coating compositions or plastics, and/or
antibacterial agent.

Other details or advantages of the invention may emerge in the light of the nonlimiting example that follows.

### EXAMPLES

### Example 1

### Synthesis of a poly(acrylamide)-block-poly(diallyldimethylammonium chloride) Diblock Copolymer

### Step 1. Synthesis of the poly(acrylamide) Block

0.52 g of O-ethyl-S-(1-methoxycarbonylethyl)xanthate of formula (CH₃CH(CO₂CH₃))S(C═S)OEt, 1.76 g of ethanol and 1.76 g of water are introduced at 30° C. into a 100 mL glass reactor equipped with a magnetic stirrer and a condensing column. The temperature of the solution is increased to 70° C. Once this temperature has been reached, 0.10 g of 4,4′-azobis(cyanovaleric acid) is introduced. Once this initiator has been introduced, 20 g of an aqueous acrylamide solution at 50% by weight are introduced over two hours. After one hour of introduction, a further 0.10 g of 4,4′-azobis(cyanovaleric acid) is introduced. The reaction is continued for 4 hours after the end of the introduction.

A sample of polymer is taken. Analysis of the product by high-performance liquid chromatography (HPLC) makes it possible to determine that all the acrylamide has reacted during the polymerization. An analysis by steric exclusion chromatography (SEC) with poly(ethylene oxide) relative calibration gives the following number-average molar mass (Mₙ) and polydispersity index (M_{w}/Mₙ) values:

Mₙ=1400 g/mol, M_{w}/Mₙ=1.40.

### Step 2. Synthesis of the Diblock Copolymer

At the end of synthesis of the first block, the temperature is reduced to 50° C. Once this temperature has stabilized, a solution of 15.38 g of diallyldimethylammonium chloride (DADMAC) at 65% by weight in water is introduced, along with 146 mg of initiator V50 (2,2′-azobis(2-methylproprionamidine)dihydrochloride). The reaction is then maintained at this temperature for 8 hours. At the end of reaction, a sample is taken. ¹H NMR analysis gives a DADMAC conversion equal to 73%. The Mₙ and M_{w}/Mₙ are measured by SEC in water: Mₙ=2800; M_{w}/Mₙ=1.27. The superposition of the two chromatograms of products A1 and A2 makes it possible to determine that the copolymer formed is of diblock nature. Specifically, the SEC chromatogram of step 1 is totally shifted toward the range of higher molecular masses at the end of step 2.

### Example 2

### Synthesis of a poly(acrylic acid)-block-poly(diallyldimethylammonium chloride) Diblock Copolymer

### Step 1. Synthesis of the poly(acrylic acid) Block

31.87 g of O-ethyl-S-(1-methoxycarbonylethyl)xanthate (CH₃CHCO₂CH₃)S(C═S)OEt, 101.3 g of ethanol, 8.5 g of acrylic acid and 23.64 g of water are introduced at room temperature into a 2 L jacketed glass reactor equipped with a mechanical stirrer and a condensing column. The temperature of the solution is increased to 70° C. Once this temperature has been reached, 0.49 g of 4,4′-azobis(cyanovaleric acid) is introduced. Once this initiator has been introduced, a solution of 76.5 g of acrylic acid in 212.8 g of water is introduced over one hour. At the end of introduction, a further 0.49 g of 4,4′-azobis(cyanovaleric acid) is introduced. The reaction is continued for 3 hours after the end of the introduction.

A sample of polymer is taken. Analysis of the product by high-performance liquid chromatography (HPLC) makes it possible to determine that all the acrylic acid has reacted during the polymerization. An analysis by steric exclusion chromatography (SEC) with poly(ethylene oxide) relative calibration gives the following number-average molar mass (Mₙ) and polydispersity index (M_{w}/Mₙ) values:

Mₙ=650 g/mol, M_{w}/Mₙ=1.60.

### Step 2. Synthesis of the Diblock Copolymer

At the end of synthesis of the first block, the temperature is reduced to 65° C. Once this temperature has stabilized, a solution of 706 g of diallyldimethylammonium chloride (DADMAC) at 65% by weight in water is introduced, along with 4 g of initiator V50 (2,2′-azobis(2-methylproprionamidine)dihydrochloride). The reaction is then maintained at this temperature for 12 hours. After 4 hours and 8 hours of reaction, a further 4 g of initiator V50 are added each time to the reaction medium. At the end of reaction, a sample is taken. ¹H NMR analysis gives a DADMAC conversion equal to 98.2%. The Mₙ and M_{w}/Mₙ are measured by SEC in water with a PDADMAC calibration curve: Mₙ=2500; M_{w}/Mₙ=1.50. The superposition of the two chromatograms of products A1 and A2 makes it possible to determine that the copolymer formed is of diblock nature. Specifically, the SEC chromatogram of step 1 is totally shifted toward the range of higher molecular masses at the end of step 2.

1. A process for preparing a compound which comprises macromolecular chains, comprising a step P of radical polymerization of the following:
at least one monomer M selected from among tertiary or quaternary diallylamines, optionally in the form of a salt,
optionally, other ethylenically unsaturated monomers,
at least one compound comprising a transfer group containing a group of the formula —S—CS—, and
a compound bearing or generating free radicals.

2. The process as defined by claim 1, wherein the monomer M is selected from among monomers having the following formulae:
CH₂═CH—CH₂—NR¹—CH₂—CH═CH₂ (I)
CH₂═CH—CH₂—N⁺R¹R²—CH₂—CH═CH₂,X⁻ (II)
CH₂═CH—CH₂—N⁺R¹R³CH₂—CH═CH₂ (III)
in which:
R¹ is a linear or branched, saturated or unsaturated hydrocarbon-based radical, optionally aromatic, optionally substituted, having from C₁-C₃₀,
R² is a hydrogen atom or an identical or different radical of formula R¹, forming, where appropriate, with the group R¹, an optionally heterocyclic, optionally aromatic ring member,
X⁻ is an anion,
R³ is a linear or branched, saturated or unsaturated hydrocarbon-based radical, which is optionally aromatic, optionally substituted, comprising at least one group bearing a negative charge, of C₁-C₃₀, forming, where appropriate, with the radical R¹, an optionally heterocyclic, optionally aromatic ring member.

3. The process as defined by claim 1, wherein the monomer M comprises diallyldimethylammonium chloride (DADMAC).

4. The process as defined by claim 1, wherein the monomer M constitutes from 1% to 100% by number of the monomers employed during the polymerization step P.

5. The process as defined by claim 1, which comprises:
before or after the polymerization step P, another step of radical polymerization of the following:
ethylenically unsaturated monomers, in a composition different than that of the polymerization step P,
at least one compound comprising a transfer group containing a group of the formula —S—CS—, and
a compound bearing or generating free radicals, and/or
after the polymerization step(s), a step of chemical modification of the macromolecular chains and/or of deactivation of the transfer groups borne by the macromolecular chains, of destruction or purification of by-products of the chemical modification and/or deactivation.

6. The process as defined by claim 5, wherein:
the macromolecular chain is a block copolymer comprising at least one block A and one block B,
the block B comprises structural units derived from the monomer M, and
the process comprises at least the following steps:
a) preparation of the block A which comprises a radical polymerization step of the following:
ethylenically unsaturated monomers,
at least one transfer agent comprising a transfer group containing a group of the formula —S—CS—,
at least one compound generating free radicals,
b) growth of the block B which comprises the polymerization step P of the following:
the product obtained in step a), comprising as block A a macromolecular chain which comprises the transfer group, and optionally a compound bearing or generating free radicals,
at least the monomer M,
optionally, other monomers, and
a compound bearing or generating free radicals, if the product obtained in step a) does not comprise any of same, and wherein:
the composition of the monomer(s) employed during step a) is different than the composition of the monomer(s) employed during step b).

7. The process as defined by claim 1, wherein the transfer group comprises a group of formula —S—CS—Z—, in which Z is an oxygen atom, a carbon atom, a sulfur atom, a phosphorus atom or a silicon atom, these atoms being substituted, where appropriate, to provide the required valency.

8. The process as defined by claim 1, wherein during at least one polymerization step, a transfer agent is employed selected from among:
O-ethyl-S-(1-methoxycarbonylethyl)xanthate of formula (CH₃CH(CO₂CH₃))S(C═S)OEt,
dibenzyl trithiocarbonate of formula φ-CH₂—S—CS—S—CH₂-φ,
phenyl benzyl dithiocarbonate of formula φ-S—CS—CH₂-φ, and
N,N-diethyl S-benzyl dithiocarbamate of formula (CH₃—CH₂)₂N—CS—S—CH₂-φ.

9. The process as defined by claim 1, wherein the polymerization step P, and/or other polymerization steps, is (are) carried out by solution or emulsion polymerization.

10. A compound comprising macromolecular chains of controlled architecture, wherein:
the macromolecular chains comprise at least 10% by number of units derived from ethylenically unsaturated monomers,
the macromolecular chains comprise units derived from at least one monomer M selected from among quaternary diallylamines, or salts thereof.

11. The compound as defined by claim 10, comprising is a copolymer of controlled architecture.

12. The compound as defined by claim 10, wherein the macromolecular chains of controlled architecture:
comprise at least one macromolecular moiety A and one macromolecular moiety B, in which:
moiety A is of different composition than moiety B, and
moiety B comprises the units derived from the monomers M, and/or
comprise a non-polymeric branching center, and macromolecular chains comprising units derived from the monomer M, such chains being bonded to the branching center.

13. The compound as defined by claim 12, having the following structure:
a block copolymer comprising at least two blocks, moiety A corresponding to one block (block A), moiety B corresponding to another block (block B),
a concentration-gradient copolymer, moiety A corresponding to a fraction that is less rich in monomer M than moiety B,
a comb copolymer, having a backbone and side chains, with moiety A corresponding to the backbone and moiety B corresponding to the side chains, or with moiety B corresponding to the backbone and moiety A corresponding to the side chains, or
a star copolymer or star microgel comprising a polymer core and peripheral macromolecular chains, at least a fraction of the moiety A or B corresponding to the core, the other moiety corresponding to the peripheral chains.

14. A compound wherein the monomer M is a monomer as defined by claim 2.

15. The compound as defined by claim 10, which comprises a block copolymer comprising at least one block A and at least one block B, optionally a diblock copolymer (block A)-(block B) or a triblock copolymer (block A)-(block B)-(block A) or (block B)-(block A)-(block B), in which:
block B comprises structural units derived from the monomer M and optionally other monomers,
block A comprises structural units derived from monomers other than the monomer M, and optionally units derived from the monomer M, in a numerical amount less than that of block B.

16. The compound as defined by claim 10, which:
comprises structural units derived from monomers other than the monomer M, and
such structural units are derived from monomers selected from among:
acrylamide, methacrylamide,
acrylic acid, methacrylic acid,
vinyllactams
acrylic or methacrylic acid esters,
acrylamide or methacrylamide amides, and
vinyl alcohol esters.

17. The compound as defined by claim 10, wherein at least 50% by number of the structural units derived from the monomer M comprise a heterocycle containing a nitrogen atom.

18. A compound prepared via the process as defined by claim 1.

19. A water-treatment or waste-processing composition, cosmetic composition, household management composition, industrial textile-treatment composition, coating composition or plastic, comprising the compound as defined by claim 10.

20. A flocculent, agent for treating and/or modifying a surface, a rheological agent, an antistatic agent or electricity-conducting agent, and/or an antibacterial agent, comprising the compound as defined by claim 10.
